(19) United States
(12) Patent Application Publication
(10) Pub. No.: US 2018/0097793 A1
(43) Pub. Date: Apr. 5, 2018

(54) SECONDARY AUTHENTICATION USING USER'S LOGIN STATUS

(71) Applicant: CA, Inc., New York, NY (US)

(72) Inventors: Gaurav AGARWAL, Bangalore (IN); Alok GUPTA, Bangalore (IN); Rahul Gurudas DHAVALIKAR, Bangalore (IN)

(73) Assignee: CA, Inc., New York, NY (US)

(21) Appl. No.: 15/282,370

(22) Filed: Sep. 30, 2016

(51) Int. Cl. H04L 29/06; H04W 12/06

(52) U.S. Cl. CPC H04L 63/083; H04L 63/101; H04W 12/06

(57) ABSTRACT

A method is described for storing a plurality of access tokens, each access token associated with a respective login credential of a plurality of login credentials, and each access token usable to access a respective account of a plurality of accounts of a user. The method further comprising receiving a transaction request from the user for a transaction with a target account and determining a respective user login status of the user for ones of the plurality of accounts using respective access tokens. The method further comprising determining which of at least two actions to take in response to determining whether the user login status of a predefined number of the plurality of accounts is active.

### TECHNICAL FIELD

The present invention relates generally to authentication, more particularly, to the management of user authorization across multiple accounts.

### BACKGROUND

Traditionally, consumers used cash to purchase the majority of goods. During the transition from cash to credit cards, consumers voiced concerns about protecting their personal information. Over time, consumers developed trust in credit cards as a payment option and the system was widely adopted. As technology continued to advance, retailers began utilizing internet portals to conduct transactions with consumers. This transition renewed consumer concern about the security of personal information.

Specifically, consumers were apprehensive about the security of their credit card or bank account information during a transaction, as well as whether or not the process was secure. To address these concerns, industries added multiple authentications of consumer identity. However, multiple authentications can be a burden to the consumer because it requires additional consumer effort to complete a transaction. For example, a consumer may be required to log into a website and subsequently provide additional information if the consumer desired to change a password or conduct payment on the website.

Accordingly, there is a need in the marketplace for a system utilizing multiple authentication that both increases security and improves the consumer experience. The present disclosure describes an authorization system capable of providing such a service. The present disclosure applies an access token system to determine login status of a user across multiple accounts in order to authenticate transaction requests. The system of the present disclosure is applicable in scenarios such as, for example, the financial industry and email systems. This distinctive solution may also be extended to applications, databases, storage, etc. Embodiments of the present disclosure may address the above problems, and other problems, individually and collectively.

### SUMMARY

According to a non-limiting embodiment of the present disclosure, a method is disclosed comprising storing a plurality of access tokens, each access token associated with a respective login credential of a plurality of login credentials, and each access token usable to access a respective account of a plurality of accounts of a user. The method further comprising receiving a transaction request from the user for a transaction with a target account and determining a respective user login status of the user for ones of the plurality of accounts using respective access tokens. The method further comprising determining which of at least two actions to take in response to determining whether the user login status of a predefined number of the plurality of accounts is active.

According to another non-limiting embodiment of the present disclosure, a system is disclosed comprising a processing system configured to perform processes comprising storing a plurality of access tokens, each access token associated with a respective login credential of a plurality of login credentials, and each access token usable to access a respective account of a plurality of accounts of a user. The processing system configured to further perform processes comprising receiving a transaction request from the user for a transaction with a target account, wherein the transaction request comprises an access request to the target account. The processing system configured to further perform processes comprising, in response to receiving the transaction request from the user, determining which of the plurality of credentials are relevant to the user, retrieving the access tokens associated with the relevant credentials, and accessing ones of the plurality of accounts using respective access tokens associated with the relevant credentials. The processing system configured to further perform processes comprising determining a respective user login status of the user for ones of the plurality of accounts using respective access tokens associated with the relevant credentials and determining which of at least two actions to take in response to determining whether the user login status of a predefined number of the plurality of accounts is active.

According to another embodiment of the present disclosure, a non-transitory computer-readable medium is disclosed having instructions stored thereon that are executable by a computing system to perform operations comprising storing a plurality of access tokens, each access token associated with a respective login credential of a plurality of login credentials, and each access token usable to access a respective account of a plurality of accounts of a user. The instructions are further executable to perform operations comprising storing a mapping of the plurality of login credentials and the plurality of access tokens to respective accounts of the plurality of accounts of the user and receiving a transaction request from the user for a payment transaction with a target account. The instructions are further executable to perform operations comprising, in response to receiving the transaction request from the user, determining via the mapping which of the plurality of credentials are relevant to the user, retrieving the access tokens associated with the relevant credentials, determining a respective user login status of the user for each of the ones of the plurality of accounts using the access tokens associated with the relevant credentials, and determining which of at least two actions to take in response to determining whether the user login status of a predefined number of the plurality of accounts is active.

It is noted that aspects described with respect to one embodiment may be incorporated in different embodiments although not specifically described relative thereto. That is, all embodiments and/or features of any embodiments can be combined in any way and/or combination. Moreover, computer equipment, systems, methods, and/or computer program products according to embodiments will be or become apparent to one with skill in the art upon review of the following drawings and detailed description. It is intended that all such additional computer equipment, systems, methods, and/or computer program products be included within this description and protected by the accompanying claims.

### BRIEF DESCRIPTION OF THE DRAWINGS

Aspects of the present disclosure are illustrated by way of example and are not limited by the accompanying drawings.

FIG. 1 illustrates the authorization ecosystem in a non-limiting embodiment of the present disclosure.

FIG. 2 illustrates a detailed authorization ecosystem in a non-limiting embodiment of the present disclosure.

FIG. 3 is a flowchart of operations and information flows that may be performed by the authorization system of a non-limiting embodiment of the present disclosure.

### DETAILED DESCRIPTION

Various embodiments will be described more fully hereinafter with reference to the accompanying drawings. Other embodiments may take many different forms and should not be construed as limited to the embodiments set forth herein. Like numbers refer to like elements throughout.

The present disclosure describes an authorization system that permits multiple authentication of a user. Specifically, the present disclosure describes an authorization system that may verify user identity on a target account by leveraging authentication of a plurality of other accounts.

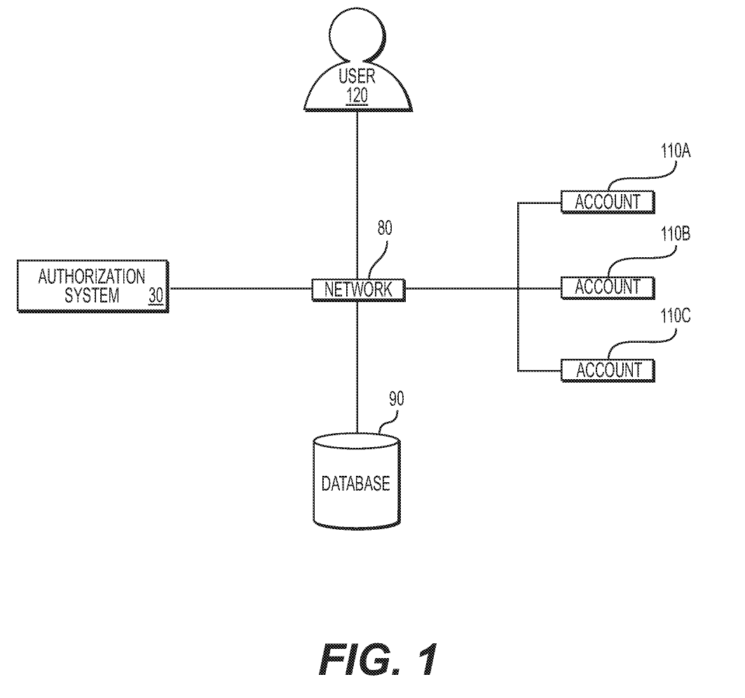

FIG. 1 illustrates the authorization ecosystem in a non-limiting embodiment of the present disclosure. An authorization ecosystem may include an authorization system 30, a network 80, a database 90, a user 120, and accounts 110A, 110B, and 110C.

Network 80 may comprise one or more entities, which may be public, private, or community based. Network 80 may permit the exchange of information and services among users/entities that are connected to such network 80. In certain configurations, network 80 may be a local area network, such as an intranet. Further, network 80 may be a closed and/or private network/cloud in certain configurations, and an open network/cloud in other configurations. Network 80 may facilitate wired or wireless communications of information and provisioning of services among users that are connected to network 80.

The authorization ecosystem may also include a database 90 which may include, for example, additional servers, data storage, and resources. Authorization system 30 may receive additional data from database 90. Authorization system 30 may also store access tokens, account information, account mapping, system analysis, and any information regarding authentication or authorization processes on the database 90. Database 90 may be any conventional database or data infrastructure. For example, database 90 may include scaled out data architectures (i.e., Apache Hadoop) and/or persistent, immutable stores/logging systems.

The authorization system 30 may interact via network 80 with user 120. In addition, user 120 may interact with authorization system 30 using any computer device, such as, for example, a mobile telephone. User 120 may interact with a plurality of accounts, such as accounts 110A, 110B, and 110C via network 80. Accounts 110A, 110B, and 110C may each be any type of account, including but not limited to bank accounts, social media accounts, and email accounts.

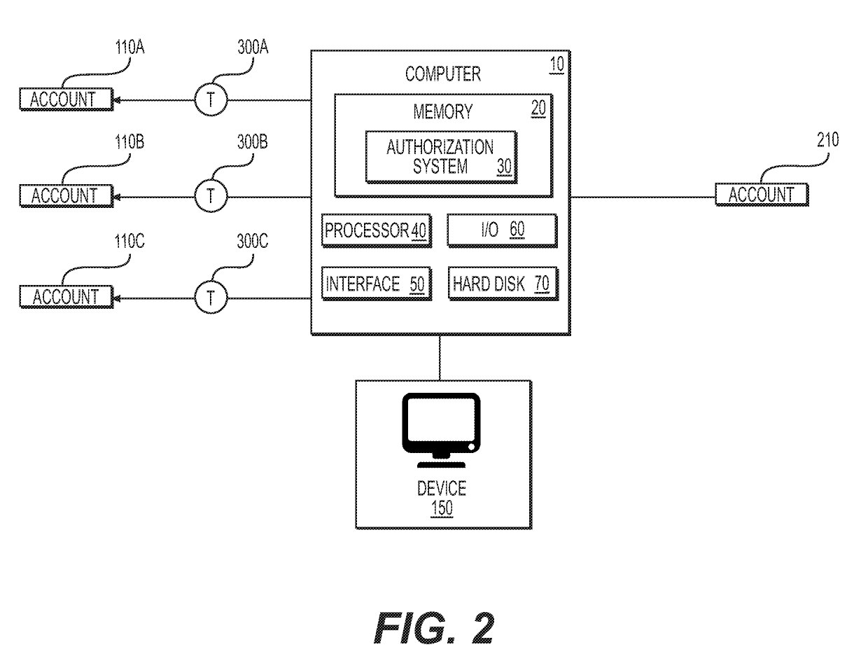

FIG. 2 illustrates a detailed authorization ecosystem in a non-limiting embodiment of the present disclosure. The authorization ecosystem may include computer 10, memory 20, authorization system 30, processor 40, interface 50, input and output (“I/O”) device 60, and hard disk 70. Authorization system 30 analysis may take place on the computer 10. Processor 40 may be operable to load instructions from hard disk 70 into memory 20 and execute those instructions. Memory 20 may store computer-readable instructions that may instruct the computer 10 to perform certain processes. I/O device 60 may receive one or more of data from another server or a network 80. The computer 10 may be a processing system, a server, a plurality of servers, or any combination thereof. Furthermore, authorization system 30 may perform analysis on any processing system, wherein the processing system comprises one or more processors.

Authorization system 30 may be located on the cloud or on an external network. In some non-limiting embodiments, authorization system 30 may be partially located on a mobile device and partially on the cloud or a network, or any combination thereof. Furthermore, some non-limiting configurations of authorization system 30 may be located exclusively on a user's device 150. Authorization system 30 may also be accessed by user 120 on a device 150. The device 150 may be any type of computing device, such as, for example, a mobile telephone.

Authorization system 30 may receive permission from user 120 to access accounts 110A, 110B, and 110C to determine whether the user 120 is actively logged into these accounts. In some non-limiting embodiments of the present disclosure, there may be a plurality accounts of multiple account types. In other non-limiting embodiments, the authorization system 30 may, upon receiving permission and/or credentials from the user 120, create access tokens that permit authorization system 30 to log into accounts 110A, 110B, and 110C.

In FIG. 2, authorization system 30 may create access tokens 300A, 300B, and 300C after receiving permission and/or credentials from user 120. Authorization system 30 may store an indication of the permission or the credentials on the cloud or on database 90. In some non-limiting embodiments, authorization system 30 may store such items locally on the device 150. In some non-limiting embodiments, authorization system 30 may create access tokens 300A, 300B, and 300C to determine the login status of the user 120 on respective accounts 110A, 110B, and 110C, for example. In other words, the authorization system 30 may create one access token for each account 110A, 110B, and 110C. Furthermore, the access token may be used by authorization system 30 to gain access to any information regarding accounts 110A, 110B, and 110C without subsequent approval from user 120.

Authorization system 30 may store a plurality of access tokens, such as access tokens 300A, 300B, and 300C. Storage may take place locally, on an external network, on the cloud, etc. Each access token may be associated with a respective login credential of a plurality of login credentials. The login credentials may be received from user 120. In some non-limiting embodiments, the authorization system 30 may request the user to validate any credential after a predetermined time. As a result, the authorization system 30 may update an access token for the relevant credential. Furthermore, each login credential may be associated with one of the plurality of accounts, such as accounts 110A, 110B, and 110C. In addition, each access token may be usable to access or determine a user login status for a respective account associated with respective login credential. For example, authorization system 30 may use access token 300A to determine a user login status for account 110A. In addition, the authorization system may store a mapping of the plurality of login credentials and the plurality of access tokens to respective accounts of the plurality of accounts of the user 120.

In some non-limiting embodiments of the present disclosure, authorization system 30 may receive a transaction request from a user or a user's device 150 for a transaction with a target account 210. The transaction request may be for any type of transaction. The transaction request may be a payment request, an access request, a confirmation request, an authentication request, etc. A user 120 may make a transaction request from any device, such as, for example, a desktop or mobile device. In some non-limiting embodiments, the user 120 may have an active login status on accounts 110A, 110B, and 110C on device 150, and the user 120 may initiate a transaction request for target account 210 on device 150. In other non-limiting embodiments, the user 120 may initiate a transaction request for a target account 210 from a separate device than device 150. The present disclosure considers all possible account/device combinations.

The target account 210 may be one of the plurality of accounts 110A, 110B, and 110C. In some non-limiting embodiments, the authorization system 30 may have created an access token for target account 210. In response to receiving the transaction request, the authorization system may determine a respective user login status of the user for any of the plurality of accounts using respective access tokens. In addition, in response to receiving the transaction request from the user, the authorization system 30 may determine which of the plurality of credentials are relevant to the user. The authorization system 30 may also retrieve the access tokens associated with the relevant credentials. The authorization system 30 may be configured to access a predetermined number of accounts to determine corresponding user login statuses. In some non-limiting embodiments, the authorization system 30 may determine which of multiple actions to take in response to determining whether the user login status of a predefined number of the plurality of accounts is active. The predefined number may be any number and may be an integer.

The authorization system 30 may take multiple actions such as, for example, authenticating the transaction with the target account and requesting additional authentication information from the user. In some non-limiting embodiments, the authorization system 30 may determine that a user login status of a predefined number of the plurality of accounts is active before initiating one of multiple actions. The authorization system 30 may be configured to not take an action unless a user login status is determined active for at least three accounts. In some non-limiting embodiments, the authorization system 30 may receive user approval to utilize user login statuses of a plurality of accounts to access target accounts or approve transaction requests therein. Furthermore, the authorization system 30 may store an indication of the user approval and include it in the mapping of access tokens.

In some non-limiting embodiments, the authorization system 30 may determine that the user login statuses of less than the predefined number of accounts are active. In such a case, the authorization system 30 may request additional authentication from the user. Additional authentication may include login credentials, usernames, passwords, access tokens, etc.

The accounts 110A, 110B, and 110C, as well as the target account 210, may all be accessible on one device, such as device 150. In addition, each account may be on separate platforms such as email platforms, social media platforms, financial platforms, etc. For example, account 110C may be a social media account and target account 210 may be an online banking account. Separate platforms may be located in separate physical locations, but each platform may communicate via the internet. In some non-limiting embodiments, accounts 110A and 110B may be on one platform, account 110C may be on a second platform, and target account 210 may be on a third platform. The target account 210 and accounts 110A, 110B, and 110C may each be, for example, one of an enterprise account, a commercial account, or a personal account. Any mentioned account may be on an individual server or share server support with any other account.

If the user 120 has an active user status on a predefined number of accounts on a device 150, such as accounts 110A, 110B, and 110C, and the user creates a transaction request with target account 210, the authorization system 30 may rely on the active user statuses as authentication of the identity of user 120. In such a case, the authorization system 30 may rely on this authentication to approve a transaction request regarding target account 210 from the user 120. The transaction request may be anything on the target account 210 that requires user credentials or identity authentication.

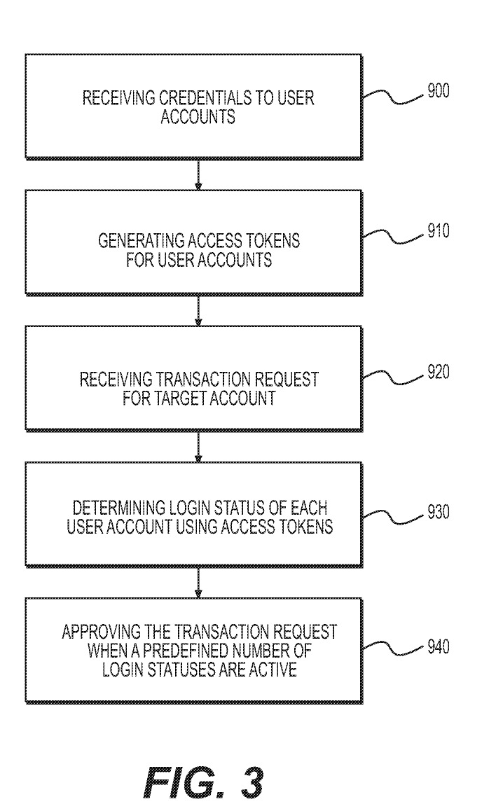

FIG. 3 is a flowchart of operations and information flows that may be performed by the authorization system 30 of a non-limiting embodiment of the present disclosure. In step 900, the authorization system 30 may receive permission and/or credentials from user 120 to access login statuses on accounts 110A, 110B, and 110C. In other words, authorization system 30 may determine if there is a valid session in any of the accounts 110A, 110B, and 110C. Authorization system 30 may receive usernames, static passwords, access tokens, or any other authentication from user 120 for accounts 110A, 110B, and 110C. In some non-limiting embodiments, user 120 may register accounts 110A, 110B, and 110C with authorization system 30. In order to log into one of the accounts 110A, 110B, and 110C, user 120 may go through an authentication process to confirm his or her identity. This authentication process may require user 120 to type in a password, answer security questions, confirm a biometric such as a thumbprint, etc. Any credentials or identity information required by an account may be transmitted to the authorization system 30 by the user 120. In some non-limiting embodiments, the authorization system 30 may receive a username and password from user 120 for account 110A, and the authorization system 30 may use these credentials to discover and record answers to security questions or biometric information of the user 120 for account 110A.

The access provided by user 120 to accounts 110A, 110B, and 110C may permit the authorization system 30 to determine whether the user 120 is actively logged into these accounts. For example, in some non-limiting embodiments, the authorization system 30 may determine that user 120 is actively logged into accounts 110A and 110B, but not account 110C. The authorization system 30 may generate access tokens 300A, 300B, and 300C using the access information provided by user 120, in order to access accounts 110A, 110B, and 110C. In some non-limiting embodiments of the present disclosure, the authorization system 30 may access account information in addition to the login status of accounts 110A, 110B, and 110C. For example, the authorization system 30 may access utilization reports, user information and identification, historical information, transaction information, payment information, or any other account information.

In step 900, the authorization system 30 may confirm the access credentials provided by the user by using the access tokens to determine user login statuses of accounts 110A, 110B, and 110C. In some non-limiting embodiments, the authorization system 30 may determine whether the user 120 has a valid session in any of accounts 110A, 110B, and 110C. In such embodiments, the authorization system 30 may have access to the identity authentication used by each account 110A, 110B, and 110C, and may further be configured to leverage this identity authentication to authorize the user's identity on a plurality of other accounts. In some non-limiting embodiments, authorization system 30 may rely on two or more accounts to verify the identity of a user 120 before leveraging this authentication to a target account 210. The authorization system 30 may determine that only a genuine user may have several active login statuses on multiple accounts 110A, 110B, and 110C.

In some non-limiting embodiments, authorization system 30 may be configured to require a predetermined amount of active login statuses on a plurality of accounts, such as accounts 110A, 110B, and 110C. For example, the authorization system 30 may be configured to require the user 120 to have two active sessions in two separate accounts before approving a transaction or authenticating a login on a target account 210. In other non-limiting embodiments of the present disclosure, the authorization system 30 may be configured to rely on active login statuses of a predefined number of accounts. The predefined number of accounts may be configured by the user 120 or dictated by requirements set forth by accounts 110A, 110B, and 110C, for example. Furthermore, in some non-limiting embodiments, authorization system 30 may require additional confirmation from user 120 in order to generate access tokens for accounts 110A, 110B, and/or 110C.

Authorization system 30 may map information regarding accounts 110A, 110B, and 110C to an authorization account of the user on the authorization system 30. In some non-limiting embodiments, authorization system 30 may map a plurality of user login statuses and relevant access tokens to the user account. Furthermore, authorization system 30 may store a plurality of account mappings in database 90, on a local or external network, or on the cloud. Authorization system 30 may determine which account mapping is relevant to a transaction or authentication request initiated by the user 120. During such requests, in some non-limiting embodiments of the present disclosure, the authorization system 30 may retrieve a corresponding access token associated with the relevant account mapping. Authorization system 30 may store and manage user accounts for multiple users. In some non-limiting embodiments of the present disclosure, a user 120 need not be registered with the authorization system 30 to take advantage of the benefits of easy access or transaction request approval on a target account 210.

In step 910, the authorization system 30 may utilize any of the information garnered from accounts 110A, 110B, and 110C to create an access token. The access token may be created from the information provided by the user 120 to gain access to any of the accounts 110A, 110B, and 110C. In some non-limiting embodiments, the information provided by the user 120 may vary depending on which account the user 120 is accessing. The access token may include user credentials and information garnered from a plurality of accounts 110A, 110B, and 110C. For example, account 110A may have an authentication process that requires specific personal information that account 110B may not require. In other non-limiting embodiments of the present disclosure, the access token may give the authorization system 30 access to the login status of each account 110A, 110B, and 110C. In some non-limiting embodiments, the access token may grant the authorization system 30 access to all account related information, including personal passwords and security information. In some non-limiting embodiments of the present disclosure, the authorization system 30 may create and edit a plurality of access tokens depending on the sensitivity of the security information associated with relevant accounts.

In step 920, the authorization system 30 may receive a transaction request initiated by the user 120 for a transaction on target account 210. The transaction may be any type of transaction, such as an access request, authentication request, or a payment request. The transaction request may be received by any medium such as, for example, via desktop computer or mobile phone. Traditionally, the user 120 would need to complete an authorization process required by target account 210 to, for example, access the respective account. In other words, although the user 120 completed the authentication process on accounts 110A, 110B, and 110C, the user 120 also needed to repeat the authentication process required by target account 210. Repeating authentication for every additional account of the user 120 creates an unnecessary burden on the user 120. In some non-limiting embodiments of the present disclosure, the authorization system 30 may leverage a user's active login status on an account on accounts 110A, 110B, and/or 110C to complete/authenticate a transaction requested by the user 120 on a target account 210, thereby relieving the user 120 of additional authentication processes. The authorization system 30 may use an access token system to access accounts 110A, 110B, and 110C in such a process. In some non-limiting embodiments, authorization system 30 may not approve the transaction or authentication request without determining the user 120 has a valid session in more than one of accounts 110A, 110B, and 110C.

In step 940, in some non-limiting embodiments, the authorization system 30 may approve a transaction request on the target account 210 when there is an active login status on at least one of the accounts 110A, 110B, and 110C. The authorization system 30 may leverage the completed identity verification on accounts 110A, 110B, and 110C to automatically grant the user 120 access to target account 210. In some non-limiting embodiments of the present disclosure, the authorization system 30 may leverage completed identity verification on accounts 110A, 110B, and 110C to automatically approve a transaction initiated by the user 120 on target account 210. In some non-limiting embodiments of the present disclosure, the user 120 may not need to input any information in order to gain access to target account 210 because the authorization system 30 has input the necessary credentials or authentication. The authorization system 30 may use an access token, user credentials, security information, biometric information, or anything else necessary to access target account 210. If the authorization system 30 lacks relevant information, it may request it from the user 120 and subsequently store it in database 90 or on the cloud. In some non-limiting embodiments, the authorization system 30 may request security information or log in credentials from the user 120 for any relevant account or for storage purposes.

Furthermore, the authorization system 30 may create a new access token to account for new credentials or security information as accounts 110A, 110B, and 110C develop. In some non-limiting embodiments, the authorization system 30 may edit an access token to account for new credentials, access, user login status, or security information of new accounts. In other non-limiting embodiments, the longer the user 120 is registered with the authorization system 30, the more security information the authorization system 30 may enquire, and the more useful the authorization system 30 may be in providing approval for transaction requests or expedient access to target accounts. Furthermore, in some non-limiting embodiments, as the authorization system 30 interacts with target accounts, the authorization system 30 may further edit the user account to include any security information it encounters. Such security information may be used in generating a new access token or updating an existing access token. In addition, should the authorization system 30 encounter security information or credentials that conflict with known security information, the authorization system 30 may notify the user 120 and request additional information or credentials.

In some non-limiting embodiments of the present disclosure, the authorization system 30 may request the user to validate the access token by confirming the credentials and security information used to create the access token. Furthermore, the authorization system 30 may submit this request after a predetermined amount of time. For example, the authorization system 30 may request the user to validate the access token every six months in order to confirm that the access token is up to date. In some non-limiting embodiments, the authorization system 30 may periodically check whether or not access tokens are valid by testing their authority on corresponding accounts.

In other non-limiting embodiments, authorization system 30 may approve a transaction or authentication request when user 120 is not logged into any accounts 110A, 110B, and 110C. The authorization system 30 may determine directly the identity of user 120 and subsequently leverage this identification to authorize transactions or requests on target account 210. In some non-limiting embodiments of the present disclosure, authorization system 30 may generate one access token for multiple accounts. This access token may compile all user credentials such that authorization system 30 may use it to determine valid login sessions across multiple accounts.

As will be appreciated by one skilled in the art, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus, and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

The flowchart and block diagrams in the figures illustrate examples of the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order illustrated in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” or “/” includes any and all combinations of one or more of the associated listed items.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method, comprising:
storing a plurality of access tokens, each access token associated with a respective login credential of a plurality of login credentials, and each access token usable to access a respective account of a plurality of accounts of a user;
receiving a transaction request from the user for a transaction with a target account;
determining, using a processor, a respective user login status of the user for ones of the plurality of accounts using respective access tokens; and
determining, using the processor, which of at least two actions to take in response to determining whether the user login status of a predefined number of the plurality of accounts is active.

2. The method of claim 1, wherein the at least two actions comprise authenticating the transaction with the target account and requesting additional authentication information from the user.

3. The method of claim 1, wherein a first action of the at least two actions comprises authenticating the transaction with the target account, and further comprising:
determining that the user login status of at least the predefined number of the plurality of accounts is active;
authenticating the transaction in response to determining that the user login status of at least the predefined number of the plurality of accounts is active.

4. The method of claim 1, wherein a first action of the at least two actions comprises requesting additional authentication from the user, and further comprising:
determining that the user login status of less than the predefined number of the plurality of accounts is active;
requesting additional authentication from the user in response to determining that the user login status of less than the predefined number of the plurality of accounts is active.

5. The method of claim 1, wherein storing the plurality of access tokens comprises storing a mapping of the plurality of login credentials and the plurality of access tokens to respective accounts of the plurality of accounts of the user.

6. The method of claim 5, further comprising:
in response to receiving the transaction request from the user, determining which of the plurality of credentials are relevant to the user; and
retrieving the access tokens associated with the relevant credentials.

7. The method of claim 1, wherein the target account is one of the plurality of accounts.

8. The method of claim 1, further comprising, prior to storing a plurality of access tokens:
receiving the plurality of credentials from the user; and
generating the plurality of access tokens.

9. The method of claim 1, wherein the predefined number is three.

10. The method of claim 1, wherein the transaction request comprises an access request to the target account.

11. The method of claim 1, wherein the plurality of accounts are all accessible on one device.

12. The method of claim 1, wherein each of the plurality of accounts and the target account are on separate platforms, and wherein at least one of the platforms is a social media platform.

13. The method of claim 1, further comprising:
requesting, after a predetermined time, the user to validate the plurality of credentials.

14. The method of claim 1, further comprising:
receiving a user approval to utilize the user login statuses of ones of the plurality of accounts to access the target account; and
storing an indication of the user approval.

15. A system comprising:
a processing system configured to perform processes comprising:
storing a plurality of access tokens, each access token associated with a respective login credential of a plurality of login credentials, and each access token usable to access a respective account of a plurality of accounts of a user;
receiving a transaction request from the user for a transaction with a target account, wherein the transaction request comprises an access request to the target account;
in response to receiving the transaction request from the user, determining which of the plurality of credentials are relevant to the user;
retrieving the access tokens associated with the relevant credentials;
accessing ones of the plurality of accounts using respective access tokens associated with the relevant credentials;
determining a respective user login status of the user for ones of the plurality of accounts using respective access tokens associated with the relevant credentials; and
determining which of at least two actions to take in response to determining whether the user login status of a predefined number of the plurality of accounts is active.

16. The method of claim 14, wherein the at least two actions comprise authenticating the transaction with the target account and requesting additional authentication information from the user.

17. The method of claim 14, wherein a first action of the at least two actions comprises authenticating the transaction with the target account, and further comprising:
determining that the user login status of at least the predefined number of the plurality of accounts is active;
authenticating the transaction in response to determining that the user login status of at least the predefined number of the plurality of accounts is active.

18. The method of claim 14, wherein a first action of the at least two actions comprises requesting additional authentication from the user, and further comprising:
determining that the user login status of less than the predefined number of the plurality of accounts is active;
requesting additional authentication from the user in response to determining that the user login status of less than the predefined number of the plurality of accounts is active.

19. The method of claim 14, wherein storing the plurality of access tokens comprises storing a mapping of the plurality of login credentials and the plurality of access tokens to respective accounts of the plurality of accounts of the user.

20. A non-transitory computer-readable medium having instructions stored thereon that are executable by a computing system to perform operations comprising:
storing a plurality of access tokens, each access token associated with a respective login credential of a plurality of login credentials, and each access token usable to access a respective account of a plurality of accounts of a user;
storing a mapping of the plurality of login credentials and the plurality of access tokens to respective accounts of the plurality of accounts of the user;
receiving a transaction request from the user for a payment transaction with a target account;
in response to receiving the transaction request from the user, determining via the mapping which of the plurality of credentials are relevant to the user;
retrieving the access tokens associated with the relevant credentials;
determining a respective user login status of the user for each of the ones of the plurality of accounts using the access tokens associated with the relevant credentials; and
determining which of at least two actions to take in response to determining whether the user login status of a predefined number of the plurality of accounts is active.
